(19) United States
(12) Patent Application Publication
(10) Pub. No.: US 2002/0137625 A1
(43) Pub. Date: Sep. 26, 2002

(54) Catalyst system based on polymer compounds comprising silasesquioxane-metal complexes

(75) Inventors: Carsten Jost, Marl (DE); Hendrikus Cornelius Louis Abbenhuis, Nuenen (DE); Rutger Anthony Van Santen, Eindhoven (DE); Maria Danuta Skowronska-Ptasinska, Eindhoven (DE); Adolph Kuehnle, Marl (DE)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: CREAVIS GESELLSCHAFT F. TECHN. U. INNOVATION MBH, Marl (DE)

(21) Appl. No.: 10/005,107

(22) Filed: Dec. 7, 2001

(30) Foreign Application Priority Data
Dec. 7, 2000 (DE) 100 60 775.6

(51) Int. Cl. B01J 31/00; C07F 5/00

(52) U.S. Cl. 502/158; 534/10; 534/15; 556/10

(57) ABSTRACT

Catalyst systems based on a polymer compound having a molecular weight Mₙ of greater than 1000 g/mol, and comprising at least one silasesquioxane-metal complex, especially useful for the oxidation and oximation of organic compounds using peroxides; processes for preparation of such catalytic systems; and processes for use of such catalytic systems.

### BACKGROUND OF THE INVENTION

1. Field of the Invention

The invention relates to a catalyst system based on a polymer compound comprising at least one silasesquioxane-metal complex, a process for its preparation and a process for the oxidation and oximation of organic compounds using peroxides and these catalyst systems.

2. Description of the Background

Lichtenhan et al, describe the synthesis of silasesquioxane-siloxane copolymers by polycondensation of bifunctional oligomeric silasesquioxanes with suitable bifunctional silane comonomers (Macromolecules 1993, 26, 2141-2142; U.S. Pat. No. 5 412 053). In addition, Lichtenhan et al, in U.S. Pat. No. 5 484 867 also describe the use of oligomeric silasesquioxanes having a reactive corner group for the synthesis of polymers. The possible functionalization of oligomeric silasesquioxanes via olefin metathesis and hydrosilylation is likewise known (U.S. Pat. No. 5 942 638, U.S. Pat. No. 5 939 576).

Metal-containing silasesquioxanes have recently become increasingly important in view of their possible use as catalysts (Abbenhuis, Chem. Eur. J. 2000, 6, 25-32). Metal silasesquioxanes have been used, for example, as homogeneous catalysts for olefin metathesis (Feher et al., J. Am. Chem. Soc. 1994, 116, 2145-2146) and olefin polymerization (Feher et al., J. Chem. Soc., Chem. Commun. 1990, 1614-1616).

Redox molecular sieves (modified zeolites, silicalites, aluminophosphates, silicoalumino-phosphates) are useful as heterogeneous catalysts for catalytic oxidation reactions of organic substrates using peroxides. The titanium silicalite TS-1 in particular can be used for the oxidation and oximation of organic compounds by means of hydrogen peroxide (Angew. Chem, 1997, 109, 1190-1211).

However, the titanium silicalite TS-1 has a rigid lattice and is not able to change its topology by means of relatively large conformational changes. Since TS-1 additionally has a relatively small pore size, its use is restricted to small substrate molecules. Larger molecules cannot diffuse into the network and thus do not reach the catalytically active Ti centers. Thus, TS-1 is suitable for, for example, the epoxidation of linear alkenes by means of H₂O₂ but the cycloolefin cyclohexene is already too large to be able to get into the pore system of TS-1 (J. Catal. 1993; 140, 71-83; J. Catal. 1991, 129, 159-167).

Homogeneously soluble Ti-silasesquioxane complexes can be regarded as low molecular weight models for silicalite compounds such as TS-1. They are not subject to the restrictions and disadvantages of TS-1 since they have freely accessible active titanium centers. The substrate range is thus not restricted to small molecules. Like TS-1, complexes of the type [TiL(R₇Si₇O₁₂)] display activity in the epoxidation of olefins (Crocker et al, J. Chem. Soc., Dalton Trans. 1999, 3791-3804; Chem. Commun. 1997, 2411-2412; U.S. Pat. No. 5 750 741). However, primarily alkyl hydroperoxides are used as stoichiometric oxidants. The economically and ecologically more favorable use of homogeneous and heterogeneous silasesquioxane-metal complexes for oxidation reactions using H₂O₂ has hitherto been restricted to just one example (van Santen, WO 98/46352) in which a homogeneously soluble polyoxotitanate was used as activator for H₂O₂.

Compared to the molecular sieve, the homogeneous catalysts do have the advantage that the substrate range is not restricted to molecules having a maximum size determined by the crystal structure of the heterogeneous catalyst. However, the homogeneous models are not sufficiently stable for industrial use. In addition, the catalyst is not recyclable since a method of selectively separating the silasesquioxanes from the reaction mixture is not known. A continuous reaction, as is sought in industrial processes, is thus not possible. Furthermore, the high cost of the catalyst and the loss of catalyst have an adverse effect on the economics of a potential process.

There are attempts at solutions based on making the homogeneously soluble silasesquioxane complexes heterogeneous by combining them with a suitable support material. In this way, the advantages of the ease of removal of the heterogeneous catalyst can be combined with the high activity of the homogeneous catalyst and its applicability to a wide range of substrates. In contrast to TS-1, the active Ti centers of Ti-silasesquioxanes which have been made heterogeneous would be freely accessible to the organic substrate molecules and would also allow the selective oxidation of medium-sized and large substrates.

One such attempt at a solution comprises, for example, making homogeneously soluble titanium-silasesquioxane complexes, e.g. [(c-C₆H₁₁)₇Si₇O₁₂]—Ti(η⁵—C₅H₅), heterogeneous by simple adsorption onto the mesoporous MCM41 zeolite and then using it as epoxidation catalyst (van Santen, Angew. Chem., Int. Ed. Engl. 1998, 37, 356-358; DE 197 30 376). However, the low loading of the support with the active component is extremely disadvantageous. The reaction rate in the epoxidation of olefins in the presence of the supported catalysts is very low compared to that in the presence of the homogeneous precursors. Furthermore, catalysts of this type have a very strong tendency to release the active component during the reaction. Thus, there are no examples of the repeated use of the catalyst system.

High molecular weight silasesquioxanes which can be prepared by polycondensation are also known. Thus, for example, Abbenhuis et al. describe a process for preparing a Ti-containing silasesquioxane gel which is based on the condensation reaction of (c-C₆H₁₁)₈Si₈O₁₁(OH)₂ with TiCl₄ or Ti(CH₂Ph)₄ (Chem. Commun. 1997, 331-332). The gel displays catalytic activity in respect of the epoxidation of olefins, but this activity is attributable to the formation of low molecular weight Ti complexes. These low molecular weight Ti complexes are formed by means of a leaching process from the heterogeneous catalyst which does not have a satisfactory stability. This reaction is thus also a simple homogeneously catalyzed reaction.

It is an object of the present invention to develop a stable, reusable catalyst system based on silasesquioxane compounds which can be separated off from the reaction system in a simple way and can be used for catalytic oxidation reactions of organic compounds of any size, i.e. without being subject to the pore size limitations of TS-1, with peroxide oxidants, in particular H₂O₂.

### SUMMARY OF THE INVENTION

It has surprisingly been found that a catalyst system based on a polymer compound which comprises at least one silasesquioxane-metal complex and has a molecular weight Mₙ of greater than 1000 g/mol can be used for the oxidation or oximation of organic compounds and can be separated off from the reaction system in a simple way.

### DETAILED DESCRIPTION OF THE INVENTION

The present invention accordingly provides a catalyst system based an a polymer compound comprising at least one silasesquioxane-metal complex, wherein the polymer compound has a molecular weight Mₙ of greater than 1000 g/mol.

The present invention likewise provides a process for preparing catalyst systems based on polymer compounds comprising at least one silasesquioxane-metal complex wherein the polymer compound is obtained by homopolymerization, copolymerization and/or grafting of a silasesquioxane compound which contains at least one unsaturated olefin radical.

Furthermore, the present invention provides a process for the oxidation or oximation of organic compounds, wherein a catalyst system as described is used.

The catalyst systems of the invention have the advantage that they can be used either in homogeneous form or in heterogeneous form and nevertheless can be separated off from the reaction mixture in a simple way.

The catalyst preparation process of the invention has the advantage that high molecular weight polymer compounds which can be used as catalyst system either in heterogeneous form or homogeneous form can be synthesized from incompletely condensed silasesquioxanes or from silasesquioxane-metal complexes which can be prepared in a wide variety in a simple manner and contain at least one unsaturated olefin radical by homopolymerization, copolymerization and/or grafting.

The catalyst system of the invention which can be used, in particular, for the oxidation or oximation of organic compounds is based on a polymer compound comprising at least one silasesquioxane-metal complex. According to the invention, this compound has a molecular weight Mₙ preferably determined by osmometry, of greater than 1000 g/mol, preferably from 5000 to 500,000 g/mol and very particularly preferably from 10,000 to 100,000 g/mol.

The molecular weight Mₙ is defined in the relevant DIN-ISO standards as the number average of the molar mass in g/mol. It is given by the weight m in g divided by the molar amount n in mol.

The molar amount can be measured, for example, by osmosis. However, Mₙ can also be determined from sections of the distribution curve obtained by gel permeation chromatography.

The silasesquioxane-metal complexes of the polymeric catalyst systems of the invention contain at least one metal of the transition groups of the Periodic Table, the lanthanides, the actinides, main group 3 and/or main group 4. The silasesquioxane-metal complexes of the catalyst systems of the invention preferably contain at least one metal of transition group 4 of the Periodic Table very particularly preferably at least titanium.

The metal content of the catalyst system is preferably such that the polymer compound comprising at least one silasesquioxane-metal complex contains from 1×10⁻⁸% by weight to 25% by weight, particularly preferably from 1×10⁻⁶% by weight to 10% by weight, of at least one metal.

The polymer compound comprises at least one silasesquioxane-metal complex of the formula I

R¹ₐR²_{b}R³ⱼSi_{c}O_{d}HₑX_{f}M_{g}Yₕ I

where

R¹=an aliphatic, aromatic, cyclic or acyclic hydrocarbon radical, with or without functional groups,

R²=an aliphatic, aromatic, cyclic or acyclic hydrocarbon radical containing at least one double bond,

R³=an aliphatic, aromatic, cyclic or acyclic hydrocarbon radical, via which the silasesquioxane-metal complex is bound to a radical of the polymer compound,

X=H, OH, halogen, an alkoxy radical and/or an organosilyl radical,

M=an element of the transition groups of the Periodic Table, a lanthanide, an actinide, an element of main group 3 and/or an element of main group 4,

Y=an anionic radical,

a=0 to 23,

b=0 to 23,

c=5 to 24,

d=12 to 48,

e=0 to 10,

f=0 to 8,

g=1 to 4,

h=0 to 12,

j=1 to 24,

with the proviso that a+b+j=c.

For the purposes of the present invention, anionic radicals Y can be both inorganic radicals such as halide ions, hydroxide ions or nitrate ions and organic radicals such as cyclopropyl, cyclobutyl, cyclopentyl, cyclohexyl or tert-butyl radicals, e.g. F⁻, Cl⁻, Br⁻, I⁻, NO₃⁻, SO₄²⁻, OAc⁻, OH⁻.

For the purposes of the present invention, aliphatic, aromatic, cyclic or acyclic hydrocarbon radicals are substituted or unsubstituted hydrocarbon radicals having from 1 to 40, preferably from 1 to 20, carbon atoms, with some of the carbon atoms being able to be replaced by heteroatoms, e.g. nitrogen, oxygen, sulfur, phosphorus or silicon. The hydrocarbon radicals may be present as branched or unbranched chains or as cyclic radicals. Examples of hydrocarbon radicals which can be used as R¹ or R³ include, without the invention being restricted to these: methyl, ethyl, propyl, n-butyl, i-butyl, pentyl, hexyl, heptyl, octyl, nonyl, dodecanyl, benzyl, phenyl, cyclopropyl, cyclobutyl, cyclohexyl, cyclopentyl, cycloheptyl, cyclododecanyl or organosilicon radicals. The above-mentioned hydrocarbon radicals can also be used as radical R² if the hydrocarbon radical has at least one multiple bond such as a double or triple bond, e.g. a propenyl, vinyl, cyclododecatrienyl, butenyl, butynyl or cyclopentenyl radical. The hydrocarbon radicals are usually bound to the silicon atom in the silasesquioxane via an Si—C bond.

The polymer compound of the catalyst system of the invention preferably comprises from 0.1′% by weight to 99% by weight, more preferably from 1 to 90% by weight and very particularly preferably from 0.3 to 35% by weight, of at least one compound of the formula I.

The polymer compounds of the catalyst system of the invention preferably comprise chains or networks of dialkylsiloxane and/or dialkylsilane copolymer units and/or alkylhydrosiloxane and/or alkylhydrosilane copolymer compounds to which the silasesquioxane-metal complexes, are bound via hydrocarbon radicals. The polymer compounds preferably comprise chains or networks of dimethylsiloxane and/or methylhydrosiloxane copolymer compounds.

The catalyst system of the invention is preferably obtained by the process of the invention for preparing catalyst systems based on a polymer compound comprising at least one silasesquioxane-metal complex, in which the polymer compound is obtained by homopolymerization, copolymerization and/or grafting of a silasesquioxane compound containing at least one unsaturated olefin radical.

As silasesquioxane compound, use is preferably made of at least one compound of the formula II

R¹ₐR²_{b}Si_{c}O_{d}HₑX_{f}M_{g}Yₕ II

where

R¹=an aliphatic, aromatic, cyclic or cyclic hydrocarbon radical, with or without functional groups,

R²=an aliphatic, aromatic, cyclic or acyclic hydrocarbon radical containing at least one double bond,

X=H, OH, halogen, an alkoxy radical and/or an organosilyl radical,

M=an element of the transition groups of the Periodic Table, a lanthanide, an actinide, an element of main group 3 and/or an element of main group 4,

Y=an anionic radical,

a=0 to 23,

b=1 to 24,

c=5 to 24,

d=12 to 48,

e=0 to 10,

f=0 to 8,

g=0 to 4,

h=0 to 12,

with the proviso that a+b=c.

It can likewise be advantageous for the silasesquioxane compound used to be at least one compound of the formula III

R¹ₐR²_{b}Si₇O₁₂M_{g}Yₕ III

where

R¹=an aliphatic, aromatic, cyclic or acyclic hydrocarbon radical, with or without functional groups,

R²=an aliphatic, aromatic, cyclic or acyclic hydrocarbon radical containing at least one double bond,

M=an element of the transition groups of the Periodic Table, a lanthanide, an actinide, an element of main group 3 and/or an element of main group 4,

Y=an anionic radical,

a=0 to 6,

b=1 to 7,

g=1,

h=1 to 3,

with the proviso that a+b=7.

It can also be advantageous for the silasesquioxane compound used to be at least one compound of the formula IV

R¹ₐR²_{b}Si₇O₁₂H₃ IV

where

R¹=an aliphatic, aromatic, cyclic or acyclic hydrocarbon radical, with or without functional groups,

R²=an aliphatic, aromatic, cyclic or acyclic hydrocarbon radical containing at least one double bond,

a=0 to 6,

b=1 to 7,

with the proviso that a+b=7,

It can likewise be advantageous for the silasesquioxane compound used to be at least one compound of the formula V

R¹ₐR²_{b}Si₁₈O₃₇H₄Ti₄ V

where

R¹=an aliphatic, aromatic, cyclic or acyclic hydrocarbon radical, with or without functional groups,

R²=an aliphatic, aromatic, cyclic or acyclic hydrocarbon radical containing at least one double bond,

a=0 to 17,

b=1 to 18,

with the proviso that a+b=24.

It is also possible to use at least one compound of the formula VI

R¹ₐR²_{b}Si₇O₁₂TiY VI

where

R¹=an aliphatic, aromatic, cyclic or acyclic hydrocarbon radical, with or without functional groups,

R²=an aliphatic, aromatic, cyclic or acyclic hydrocarbon radical containing at least one double bond,

Y=an anionic radical,

a=0 to 6,

b=1 to7,

with the proviso that a+b=7, as silasesquioxane compound.

The silasesquioxane compounds used are very particularly preferably compounds of the formula IV or VI.

Compounds of the formula IV, whose structure VII is shown below, can be obtained by polycondensation of trifunctional RSiZ₃ precursors, where R is a hydrocarbon radical and Z is a hydrolyzable group such as chloro, alkoxy or siloxy (J. Am. Chem. Soc. 1989, 111, 1741-1748, Organometallics 1991, 10, 2526-2528; Chem. Commun. 1999, 2153-2154). However, an advantageous synthesis is that via an oligomeric silasesquioxane of the formula R₆Si₆O₉, since this makes possible a wide variation of the hydrocarbon radicals and thus enables the properties of the catalyst to be more readily matched to the particular reaction.

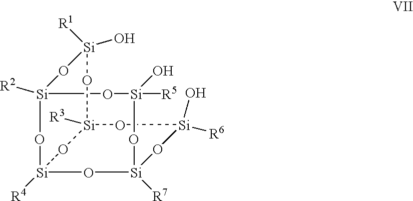

However, for the compound of the structure VII to be able to be used in the process of the invention, it is absolutely necessary for at least one radical R to contain as unsaturated olefinic bond.

Compounds of the formula V, whose structure VIII is depicted below, are obtainable by reaction of titanium compounds with incompletely condensed silasesquioxane compounds of the type R₆Si₆O₇(OH)₄. The preparation of compounds of the type VIII is described in WO 98/46352. For compounds of the structure VIII to be used as silasesquioxane compound in the process of the invention, it is once again necessary for the compound to contain at least one radical R containing an unsaturated olefinic bond. Subject to this condition, the radicals R can be identical or different.

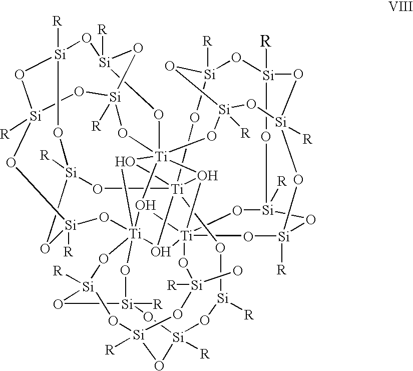

It can also be advantageous to build up relatively high. molecular weight compounds by condensation of the silasesquioxane compounds in a first step, and then to use these for the homopolymerization, copolymerization or grafting reaction.

In the process of the invention, a copolymerization and/or grafting reaction of at least one silasesquioxane compound, preferably one of the abovementioned silasesquioxane compounds of the formulae II to VI, with at least one compound containing at least one olefinically unsaturated bond and/or at least one H-heteroatom group is carried out. The compound or compounds containing an olefinically unsaturated bond and/or at least one H-heteroatom group can be, for example, a siloxane or a silasesquioxane compound.

In a particular embodiment of the process of the invention, the preparation is carried out by homopolymerization of a silasesquioxane compound or its metal complex. Examples of polymerization reactions are, inter alia, especially free-radical polymerization, ionic polymerization and ring-opening metathesis (ROMP).

In a further particular embodiment of the process of the invention, the catalyst system of the invention is prepared by copolymerization of a silasesquioxane compound or its metal complex with a further silasesquioxane or the corresponding metal complex or an organic or inorganic compound capable of polymerization. Examples of such polymerization reactions are, inter alia, especially free-radical polymerization, ionic polymerization and ring-opening metathesis (ROMP). Comonomers which can be used include, among many others, especially silasesquioxanes or their metal complexes containing at least one unsaturated olefin radical and also ethylene, propylene, styrene, vinyl chloride, allyl alcohol, acrylic acid, methacrylic acid and maleic anhydride.

In a further particular embodiment of the process of the invention, the catalyst system of the invention is prepared by a grafting reaction of a silasesquioxane compound containing at least one unsaturated bond with a compound containing at least one olefinically unsaturated bond or at least one Si—H group. Examples of compounds which can be grafted on include, among many others, especially polymeric silasesquioxanes, silicones, siloxanes such as polysiloxanes and dendrimers.

In a further particularly preferred embodiment of the process of the invention, the catalyst system of the invention is prepared by reaction of a silasesquioxane compound containing at least one olefinically unsaturated bond with at least one siloxane containing Si—H groups in such a way that the reaction leaves unreacted Si—H groups which can be used for a further crosslinking reaction. Compounds suitable for this crosslinking reaction are, for example, silicones, siloxanes and silazanes, or polymers of these compounds which contain olefinically unsaturated bonds. Particularly preferably, a silasesquioxane compound or a silasesquioxane metal complex is first reacted with at least one methylhydrosiloxane-dimethylsiloxane copolymer of the formula IX

(CH₃)₃Si—O[SiHCH₃—O]ₘ—[Si(CH₃)₂—O]ₘ—Si(CH₃)₃ IX

where the ratio of methylhydrosiloxane units to dimethylsiloxane units in the polymers used can be from 5:1 to 1:10, preferably from 1:1 to 1:5. Owing to the variable structure of the copolymers of the formula IX, m and n do not necessarily have to be integers. The index m can assume values from 3 to 20, preferably from 3.8 to 13.5. The index n can assume values from 4 to 30, preferably from 13.5 to 21.4. The copolymers of the formula IX used preferably have a molecular weight M_{w} of from 300 g/mol to 5,000 g/mol, very particularly preferably from 900 g/mol to 2,000 g/mol. The maximum number of Si—H bonds available for coupling with a silasesquioxane compound or a silasesquioxane-metal complex containing at least one unsaturated olefinic bond can be calculated from the magnitude of the index m. All or some of these Si—H bonds can be reacted with silasesquioxane compounds or silasesquioxane-metal complexes. Preference is given to using from 1 to 100%, particularly preferably from 5 to 50% and very particularly preferably from 10 to 20%, of the Si—H bonds in the reaction with silasesquioxane compounds or silasesquioxane-metal complexes.

The reaction is preferably carried out by mixing the components, i.e., the silasesquioxane compounds or silasesquioxane-metal complexes, with at least one compound of the formula IX, preferably using a catalyst, particularly preferably a platinum catalyst and very particularly preferably a platinum-divinyltetramethyldisiloxane complex as catalyst.

If the polymer compounds obtained in this way still contain reactive groups such as unreacted Si—H bonds, they can be reacted with further compounds which contain an unsaturated olefinic double bond. Such crosslinking reactions enable the molecular weight and the size of the polymer compound in the catalyst system of the invention to be influenced. As crosslinker, preference is given to using at least one compound of the formula X,

(CH₂═CH)—Si(CH₃)₂—O—[Si(CH₃)₂—O]ₚ—Si(CH₃)₂—(CH═CH₂) X

where the index p can assume values from 1 to 200, preferably from 5 to 150. The preparation of the reaction mixture is preferably carried out so that the ratio of Si—H bonds to Si-vinyl bonds in the reaction mixture is from 3:1 to 1:1, preferably from 2:1 to 1:1 and very particularly preferably 1.5:1.

As silane or siloxane compounds, particular preference is given to using chains or networks of dialkylsiloxane and/or dialkylsilane copolymer units and/or alkylhydrosiloxane and/or allylhydrosilane copolymer compounds. Very particular preference is given to using dimethylsiloxane and/or methylhydrosiloxane copolymer compounds of the formulae IX and/or X for preparing the catalyst system based on polymer compounds comprising high molecular weight silasesquioxane-metal complexes.

In a further, preferred embodiment of the process of the invention, the catalysts of the invention are prepared by reacting a silasesquioxane compound containing at least one olefinically unsaturated bond with a dendrimer, e.g. Si[CH₂CH₂Si(CH₃)₂CH₂CH₂[SiCH₃(H)₂]]₄. Examples of further suitable dendrimers are the compounds described by Seyferth et al. (Organometallics, 1994, 13, 2682-2690).

The polymer compound on which the catalyst system of the invention is based can, depending on the crosslinker used, have a content of silasesquioxane compounds or silasesquioxane-metal complexes of from 0.1 to 99% by weight, preferably from 1 to 90% and very particularly preferably from 3 to 35% by weight.

The preparation of the catalyst system can be carried out in bulk, i.e. without use of solvents. However, the preparation can also be carried out in the liquid phase, preferably using an aprotic solvent. As aprotic solvent, it is possible to use, for example, toluene or hexane.

The polymerization is preferably carried out at from 0° C. to 100° C.

The polymerization reactions are preferably continued for the time necessary to form molecules having a molecular weight Mₙ of greater than 1,000 g/mol. The duration of the polymerization reaction is preferably controlled via the amount of compounds used. However, it can also be advantageous to interrupt the polymerization reaction. The polymerization reactions can depending on the type of polymerization reaction, be interrupted by addition of compounds which stop the reaction. In the case of a free-radical polymerization, the polymerization reaction can be stopped by addition of a free-radical trap to the reaction solution.

In the case of the exclusive use of silasesquioxane compounds which do not contain a metal, e.g. compounds of the formula IV, for the preparation of the catalyst systems of the invention, the polymerization is followed by modification of the polymer compound resulting from the homopolymerization, copolymerization or grafting reaction by means of a metal. This modification is preferably carried out by addition of a metal salt. A very large number of components are conceivable, in particular those which can react with a tridentate silanol. Examples of such compounds are Ti(OtBu)₄, Zr(OtBu)₄ and VO(acac)₂.

The modification of the polymer compound having a molecular weight Mn of over 1,000 g/mol and comprising at least one silasesquioxane compound is very particularly preferably carried out by spraying the polymer compound with a metal salt solution, by steeping the polymer compound in a metal salt solution or by dissolving the polymer compound in a metal salt solution.

The catalyst systems of the invention are suitable for many reactions. They can be employed, for example, for catalyzing isomerization reactions, hydrogenation reactions, oxidation reactions using oxygen, hydrogen peroxide, organic peroxides or N₂O, alkylation reactions, metathesis reactions, disproportionation reactions, dehydrogenation reactions, alcohol formation from olefins, coupling reactions, substitution reactions, cycloaddition reactions, cycloreversion reactions or ether formation, with these examples being purely illustrative without restricting the scope of the invention. In particular, the catalyst systems of the invention can be used in processes for the oxidation or oximation of organic compounds.

In these processes, the catalyst system can be used as a heterogeneous or homogeneous catalyst. If the catalyst is used as a heterogeneous catalyst, it can be removed from the reaction mixture present in the oxidation by, for example, simple filtration methods.

If the catalyst is used as a homogeneous catalyst, it can be removed from the reaction solution present in the oxidation by means of, for example, at least one membrane. However, it is also possible, for example, to precipitate the homogeneous catalyst after the reaction, e.g., by addition of a solvent in which the catalyst is not soluble.

In processes for the oxidation and/or oximation of organic compounds in which the catalyst system of the invention is used, the oxidate used can be either hydrogen peroxide or an organic peroxide. Organic peroxides which can be used are, for example, tert-butyl hydroperoxide, ethylbenzene hydroperoxide and/or cumene hydroperoxide.

The compound to be oxidized or oximated by means of the process of the invention can be at least one cyclic or acyclic, monounsaturated or polyunsaturated compound selected from among alkanes, alkenes, alkynes, arenes, heteroalkenes, alcohols, aldehydes, ketones, sulfides, sulfoxides, amines, imines, hydroxylamines, acids, amides, esters, anhydrides and acid halides.

The catalyst systems for oxidation and/or oximation reaction which can be prepared by the process of the invention are recyclable and can be used for further reaction cycles. This can, of course, also follow regeneration of the catalyst, e.g. by washing.

The process of the invention for preparing the catalyst system of the invention and the use according to the invention of the catalyst system are illustrated in the following examples without the invention being restricted to these examples.

### EXAMPLE 1

Preparation of high molecular weight silasesquioxane catalysts

10 g of a methylhydrosiloxane-dimethylsiloxane copolymer HMS-151 (from ABCR), viz. a compound of the formula IX in which the index m is 3.8 and the index n is 21.4, are admixed with 4.4 g of (C₆H₁₁)₆(CH₂CH)Si₇O₉(OH)₃ dissolved in a little toluene. A few drops of a platinum-divinyltetramethyldisiloxane complex solution (200 ppm of platinum-divinyltetramethyldisiloxane in xylene) are subsequently added. The reaction mixture is stirred at room temperature for 10 minutes. This is followed by addition of 85 g of DMS-V21 (a polydimethylsiloxane of the formula X containing terminal vinyl groups, in which the index p is 78, likewise from ABCR). After 5 hours at 50° C., a polymer compound is obtained. The molecular weight Mₙ of the polymer compound is 19,000.

### EXAMPLE 1a

1.7 g of Ti(OBu^{t})₄ are added to the substance from Example 1 in 11 of toluene, and the reaction mixture is stirred for 30 minutes. The solid is subsequently filtered off and washed with acetonitrile. The resulting solid has a Ti content of 0.2% by weight.

### EXAMPLE 1b

1.9 g of Zr(OBu^{t})₄ are added to the substance from Example 1 in 100 ml of toluene, and the reaction mixture is stirred for 30 minutes. The solid is subsequently filtered off and washed with acetonitrile. The resulting solid has a Zr content of 0.4% by weight.

### EXAMPLE 1c

1.8 g of vanadyl acetylacetonate are added to the substance from Example 1 in 100 ml of toluene, and the reaction mixture is stirred for 30 minutes. The solid is subsequently filtered off and washed with acetonitrile. The resulting solid has a V content of 0.2% by weight.

### EXAMPLE 2

10 g of the methylhydrosiloxane-dimethylsiloxane copolymer HMS-301 (from ABCR), viz. a compound of the formula IX in which the index m is 6.4 and the index n is 19.3, are admixed with 29 g of (C₆H₁₁)₆(CH₂CH)Si₇O₉(OH)₃ dissolved in toluene. A few drops of a platinum-divinyltetramethyldisiloxane complex solution (200 ppm of platinum-divinyltetramethyl-disiloxane in xylene) are subsequently added. The reaction mixture is stirred at room temperature for 10 minutes. After 5 hours at 50° C., a polymer compound is obtained. The molecular weight Mₙ of the polymer compound is 7,500.

### EXAMPLE 2a

11.9 g of Ti(OBu^{t})₄ are added to the substance from Example 2 in 100 ml of toluene, and the reaction mixture is stirred for 30 minutes. The solid is subsequently filtered off and washed with acetonitrile. The resulting solid has a Ti content of 3.2% by weight.

### EXAMPLE 2b

13.4 g of Zr(OBu^{t})₄ are added to the substance from Example 2 in 100 ml of toluene, and the reaction mixture is stirred for 30 minutes. The solid is subsequently filtered off and washed with acetonitrile. The resulting solid has a Zr content of 6.0% by weight.

### EXAMPLE 2c

12.2 g of vanadyl acetylacetonate (VO(acac)₂) are added to the substance from Example 2 in 100 ml of toluene, and the reaction mixture is stirred for 30 minutes. The solid is subsequently filtered off and washed with acetonitrile. The resulting solid has a V content of 3.3% by weight.

### EXAMPLE 3

10 g of a methylhydrosiloxane-dimethylsiloxane copolymer HMS-151 (from ABCR) viz. a compound of the formula IX in which the index m is 3.8 and the index n is 21.4, are admixed, with 4.9 g of (C₆H₁₁)₆(CH₂CH)Si₇O₉Ti(C₅H₅) dissolved in, a little toluene. A few drops of a platinum-divinyltetramethyldisiloxane complex solution (200 ppm of platinum-divinyltetramethyldisiloxane in xylene) are subsequently added. The reaction mixture is stirred at room temperature for 10 minutes. This is followed by addition of 85 g of DMS-V21 (a polydimethylsiloxane of the formula X containing terminal vinyl groups, in which the index p is 78, likewise from ABCR). After 5 hours at 50° C., a polymer compound is obtained. Mₙ is 19,300. The resulting solid has a Ti content of 0.2% by weight.

### EXAMPLE 4

10 g of a methylhydrosiloxane-dimethylsiloxane copolymer HMS-151 (from ABCR), 25 viz. a compound of the formula IX in which the index m is 3.8 and the index n is 21.4, are admixed with 32.5 g of (C₆H₁₁)₆(CH₂CH)Si₇O₉(C₅H₅) dissolved in a little toluene. A few drops of a platinum-divinyltetramethyldisiloxane complex solution (200 ppm of platinum-divinyltetramethyldisiloxane in xylene) are subsequently added. The reaction mixture is stirred at room temperature for 10 minutes. After 5 hours at 50° C., a polymer compound is obtained. Mₙis 7,400, The resulting solid has a Ti content of 3.4% by weight.

### (COMPARATIVE) EXAMPLE 5

Catalytic oxidation of 1-octene

0.16 mol of 1-octene and 0.16 mol of H₂O₂ (35% in H₂O) are mixed in the presence of 0.5 g of TS-1 catalyst. After a reaction time of 24 hours at a temperature of 50° C., 1,2-epoxyoctane is obtained in a yield of 91% (determined by GC).

### EXAMPLE 6

Catalytic oxidation of 1-octene

0.16 mol of 1-octene and 0.16 mol of H₂O₂ (35% in H₂O) are mixed in the presence of 0.5 g of the Ti catalyst prepared as described in Example 1a. After a reaction time of 24 hours at temperature of 50° C., 1,2-epoxyoctane is obtained in a yield of 91% (determined by GC).

### (COMPARATIVE) EXAMPLE 7

Catalytic oxidation of cyclooctene

0.16 mol of cyclooctene and 0.736 mol of H₂O₂ (35% in H₂O) are mixed in the presence of 0.5 g of TS-1 catalyst. After a reaction time of 24 hours at a temperature of 50° C., a yield of 7% of 1,2-epoxycyclooctane is obtained (determined by GC).

### EXAMPLE 8

Catalytic oxidation of cyclooctene

0.16 mol of cyclooctene and 0.736 mol of H₂O₂ (35% in H₂O) are mixed in the presence of 0.5 g of the Ti catalyst prepared as described in Example 1a. After a reaction time of 24 hours at a temperature of 50° C., a yield of 79% of 1,2-epoxycyclooctane is obtained (determined by GC).

The experimental results from Examples 5 to 8 clearly show that when a conventional catalyst and a catalyst according to the invention are used for catalyzing a process for the oxidation of linear 1-octene (Examples 5 and 6), no difference in the yield of the oxidation product 1,2-epoxyoctane can be observed. However, if the two catalysts are used in a process for the oxidation of a bulky alkene such as cyclooctene (Examples 7 and 8), it can be seen that the yield when using the catalyst according to the invention (Example 8: yield=79%) is substantially greater than when using the known TS-1 catalyst (Example 7: yield=7%).

### EXAMPLE 9

Preparation of (cyclohexyl)₆(vinyl)Si₇O₁₂TiOPrⁱ

0.91 ml (3 mmol) of Ti(OPrⁱ)₄ was added to 2.75 g (3 mmol) of (cyclohexyl)₆(vinyl)Si₇O₉(OH)₃ in 25 ml of hexane. This mixture was stirred at a temperature of 50° C. for 1.5 hours. After the end of the stirring time, this solvent was evaporated. This gave 3.03 g of a white powder which was identified as the compound (cyclohexyl)₆(vinyl)Si₇O₁₂TiOPrⁱ by ¹H-NMR (CDCl₃) and ²⁹Si-NMR (CDCl₃).

### EXAMPLE 10

Preparation of (cyclohexyl)₆(vinyl)Si₇O₁₂TiCp

0.658 g (3 mmol) of CpTiCl₃ and subsequently 1.5 ml of pyridine were added to 2.75 g (3 mmol) of (cyclohexyl)₆(vinyl)Si₇O₉(OH)₃ in 35 ml of toluene. This mixture was stirred at room temperature for one hour. After the end of the stirring time, the solution was filtered and the filtrate was concentrated to a volume of 10 ml. After addition of 10 ml of acetonitrile, white crystals could be isolated. The white crystals were identified as (cyclohexyl)₆(vinyl)Si₇O₁₂TiCp by ¹H-NMR (CDCl₃) and ²⁹Si-NMR (GDGl₃). The yield was 78%.

### EXAMPLE 11

Preparation of a catalyst system

720 mg of (cyclohexyl)₆(vinyl)Si₇O₁₂TiOprⁱ, dissolved in 3 ml of hexane, and two drops of platinum-divinyltetramethyldisiloxane complex solution (200 ppm of platinum-divinyltetramethyldisiloxane in xylene, from Gelest) are added to 3 g of the methylhydrosiloxanedimethylsiloxane copolymer HMS-301 (from ABCR), viz. a compound of the formula IX in which the index m is 6.4 and the index n is 19.3, dissolved in 5 ml of hexane. The reaction mixture is stirred at room temperature for 30 minutes. 2.4 g of vinyl-terminated polydimethylsiloxane (DMS-VO5 from Gelest) are mixed with 3 ml of hexane and two drops of a platinum-divinyltetramethyldisiloxane complex solution (200 ppm of platinum-divinyltetramethyldisiloxane in xylene, from Gelest) were subsequently added to the reaction mixture. The reaction mixture was stirred for 30 minutes, then poured onto a glass plate and solidified overnight at a temperature of 80° C. The brittle polymer compound obtained was ground in a mortar, admixed with 10 ml of moist diethyl ether and stirred for two hours in order to hydrolyze the Ti-OPrⁱ to TiOH. The mixture is subsequently extracted continuously with diethyl ether for two days to remove soluble impurities. After filtering off from the diethyl ether and drying of the filter residue, 4.8 g of a polymer compound according to the invention comprising a silasesquioxane-metal complex (polymer 11) were obtained.

### EXAMPLE 12

Preparation of a catalyst system

410 mg of (cyclohexyl)₆(vinyl)Si₇O₁₂TiOPrⁱ, dissolved in 3 ml of hexane, and two drops of a platinum-divinyltetramethyldisiloxane complex solution (200 ppm of platinum-divinyltetramethyldisiloxane in xylene, from Gelest) are added to 2 g of the methylhydrosiloxane dimethylsiloxane copolymer HMS-151 (from ABCR), viz, a compound of the formula IX in which the index m is 3.8 and the index n is 21.4, dissolved in 5 ml of hexane. The reaction mixture is stirred at room temperature for 30 minutes. 1.06 g of vinyl-terminated polydimethylsiloxane (DMS-VO5, from Gelest) are mixed with 3 ml of hexane and two drops of a platinum-divinyltetramethyldisiloxane complex solution (200 ppm of platinum-divinyltetramethyldisiloxane in xylene, from Gelest) were subsequently added to the reaction mixture. The reaction mixture was stirred for 30 minutes, then poured onto a glass plate and solidified overnight at a temperature of 80° C. The brittle polymer compound obtained was ground in a mortar, admixed with 10 ml of moist diethyl ether and stirred for two hours in order to hydrolyze the Ti—OPrⁱ to TiOH. The mixture is subsequently extracted continuously with diethyl ether for two days to remove soluble impurities. After filtering off from the diethyl ether and drying of the filter residue, 4.8 g of a polymer compound according to the invention comprising a silasesquioxane-metal complex (polymer 12) were obtained.

### EXAMPLE 13

Preparation of a catalyst system

250 mg of (cyclohexyl)₆(vinyl)Si₇O₁₂TiOPrⁱ, dissolved in 3 ml of hexane, and two drops of platinum-divinyltetramethyldisiloxane complex solution (200 ppm of platinum-divinyltetramethyldisiloxane in xylene, from Gelest) are added to 0.43 g of the methylhydrosiloxane dimethylsiloxane copolymer HMS-151 (from ABCR), viz. a compound of the formula IX in which the index m is 3.8 and the index n is 21.4, dissolved in 5 ml of hexane. The reaction mixture is stirred at room temperature for 30 minutes. 1.44 g of vinyl-terminated polydimethylsiloxane (DMS-V2 1, from Gelest) are mixed with 3 ml of hexane and two drops of a platinum-divinyltetramethyldisiloxane complex solution (200 ppm of platinum-divinyltetramethylydisiloxane in xylene, from Gelest) were subsequently added to the reaction mixture. The reaction mixture was stirred for 30 minutes, then poured onto a glass plate and solidified overnight at a temperature of 80° C. The brittle polymer compound obtained was ground in a mortar, admixed with 10 ml of moist diethyl ether and stirred for two hours in order to hydrolyze the Ti-OPrⁱ to TiOH. The mixture is subsequently extracted continuously with diethyl ether for two days to remove soluble impurities. After filtering off from the diethyl ether and, drying of the filter residue, 1.4 g of a polymer compound according to the invention comprising a silasesquioxane-metal complex (polymer 13) were obtained.

### EXAMPLE 14

Preparation of a catalyst system

727 mg of (cyclohexyl)₆(vinyl)Si₇O₁₂TiCp, dissolved in 3 ml of toluene, and two drops of a platinum-divinyltetramethyldisiloxane complex solution (200 ppm of platinum-divinyltetramethyldisiloxane in xylene, from Gelest) are added to 3 g of the methylhydrasiloxane-dimethylsiloxane copolymer HMS-301 (from ABCR), viz. a compound of the formula IX in which the index m is 6.4 and the index n is 19.3, dissolved in 5 ml of toluene. The reaction mixture is stirred at room temperature for 30 minutes. 2.4 g of vinyl-terminated polydimethylsiloxane (DMS-VO5, from Gelest) are mixed with 3 ml of toluene and two drops of a platinum divinyltetramethyldisiloxane complex solution (200 ppm of platinum-divinyltetramethyldisiloxane in xylene from Gelest) were subsequently added to the reaction mixture. The reaction mixture was stirred for 30 minutes, then poured onto a glass plate and solidified overnight at a temperature of 80° C. The brittle polymer compound obtained was ground in a mortar, admixed with 10 ml of moist diethyl ether and stirred for two hours. The mixture is subsequently extracted continuously with diethyl ether for two days to remove soluble impurities. After filtering off from the diethyl ether and drying of the filter residue, 5.1 g of a polymer compound according to the invention comprising a silasesquioxane-metal complex (polymer 14) were obtained.

### EXAMPLE 15

Preparation of a catalyst support

647 mg of (cyclohexyl)₆(vinyl)Si₇O₉(OH)₃, dissolved in 4 ml of toluene, and two drops of platinum-divinyltetramethyldisiloxane complex solution (200 ppm of platinum-divinyltetramethyldisiloxane in xylene, from Gelest) are added to 3 g of the methylhydrosiloxane-dimethylsiloxane copolymer HMS-301 (from ABCR), viz. a compound of the formula IX in which the index m is 6.4 and the index n is 19.3, dissolved in 4 ml of hexane. The reaction mixture is stirred at room temperature for 30 minutes. 2.4 g of vinyl-terminated polydimethylsiloxane (DMS-VO5, from Gelest) are mixed with 3 ml of hexane and two drops of a platinum-divinyltetramethyldisiloxane complex solution (200 ppm of platinum-divinyltetramethyldisiloxane in xylene, from Gelest) were subsequently added to the reaction mixture. The reaction mixture was stirred for 15 minutes, then poured onto a glass plate and solidified overnight at a temperature of 80° C. 5.2 g of a catalyst support (polymer 15) were obtained.

### EXAMPLE 16

Preparation of a catalyst system using the catalyst support from Example 15

0.2 ml of Ti(OPrⁱ)₄ was added to a suspension of 4.75 g of the catalyst support (polymer 15) from Example 15 in 40 ml of dry toluene. This suspension was stirred for 4 hours at a temperature of 50° C. and subsequently stirred overnight at room temperature. The same amount of Ti(OPrⁱ)₄ was once again added to the suspension and the mixture was stirred for another 24 hours. The polymer obtained was filtered off, washed twice with 50 ml of dry diethyl ether and extracted continuously with dry diethyl ether for 2 days. A polymer compound according the invention (polymer 16) was obtained.

### EXAMPLE 17

Catalytic epoxidation

Epoxidations were carried out using the catalyst systems polymer 11, 12, 13, 14, 15 and 16 from the corresponding examples. The epoxidations were carried out at a temperature of 50° C. in 2 ml batch reactors which had been charged with about 60 mg of the respective catalyst system. For the epoxidation using tert-butyl hydroperoxide (TBHP), a solution of 1.8 mmol of TBHP and 1.8 mmol of cyclooctene in 1 ml of isooctane was employed. For the epoxidation of cyclooctene using aqueous hydrogen peroxide, a mixture of 200 mg of a 35% strength aqueous solution of hydrogen peroxide and 960 mg of cyclooctane was employed.

The reaction mixtures obtained after the reaction were analysed by gas chromatography. This was carried out using a “Carlo Erba GC6000 Vega Series” gas chromatograph (GC) equipped. with a DB-1 capillary column and an FID. For this purpose, all samples contained 1,3,5-trimethylbenzene (>98%, Merck) as internal GC standard.

The following table lists the results of the epoxidation experiments using the various catalyst systems. The yield of epoxide is based on the amount of cyclooctene used.

| | Yield of epoxide in % after a reaction time of 24 h | |
|---|---|---|
| Catalyst system | tert-Butyl hydroperoxide | Hydrogen peroxide |
| Polymer 11 | 55 | 90 |
| Polymer 12 | 70 | 61 |
| Polymer 13 | — | 59 |
| Polymer 14 | 69 | 65 |
| Polymer 15 | — | <1 |
| Polymer 16 | 74 | 76 |

It can be clearly seen from the table that the polymer 15 which comprises no silasesquioxane-metal complex displays no catalytic activity in respect of the epoxidation of cyclooctene. Depending on the polymer used and the oxidant used, various yields are obtained. The highest yield when using TBHP is obtained when polymer 16 is employed. When using hydrogen peroxide as oxidant, the highest yield (90%) is achieved when the catalyst system polymer 11 is employed.

The term “functional groups” as used herein is intended to include all possible groups without restriction that can react with another group.

The disclosure of German application 10060775.6, filed Dec. 7, 2000, the priority of which is claimed herein, is hereby incorporated by reference.

1. A catalyst system comprising a polymer compound comprising at least one silasesquioxane-metal complex,
wherein the polymer compound has a molecular weight Mₙ of greater than 1000 g/mol.

2. The catalyst system as claimed in claim 1,
wherein the metal of said silasesquioxane-metal complex is at least one metal selected from the group consisting of the transition groups of the Periodic Table, the lanthanides, the actinides, main group 3 and main group 4.

3. The catalyst system as claimed in claim 2,
wherein the metal is at least one metal of the transition group of the Periodic Table.

4. The catalyst system as claimed in claim 3,
wherein the metal is at least titanium.

5. The catalyst system as claimed in claim 1,
wherein the polymer compound comprising at least one silasesquioxane-metal complex contains from 1×10⁻⁸% by weight to 25% by weight of at least one metal.

6. The catalyst system as claimed in claim 5,
wherein the polymer compound comprising at least one silasesquioxane-metal complex contains from 1×10⁻⁶% by weight to 10% by weight of at least one metal.

7. The catalyst system as claimed in claim 1,
wherein the polymer compound comprises at least one silasesquioxane-metal complex of the formula I
R¹ₐR²_{b}R³ⱼSi_{c}O_{d}HₑX_{f}M_{g}Yₕ I
where
R¹=an aliphatic, aromatic, cyclic or acyclic hydrocarbon radical, with or without functional groups,
R²=an aliphatic, aromatic, cyclic or acyclic hydrocarbon radical containing at least one double bond,
R³=an aliphatic, aromatic, cyclic or acyclic hydrocarbon radical, via which the silasesquioxane-metal complex is bound to a radical of the polymer compound,
X=one or more of H, OH, halogen, an alkoxy radical, and organosilyl radical,
M=one or more of an element of the transition groups of the Periodic Table, a lanthanide, an actinide, an element of main group 3 and an element of main group 4,
Y=an anionic radical,
a=0 to 23,
b=0 to 23,
c=5 to 24,
d=12 to 48,
e=0 to 10,
f=0 to 8,
g=0 to 4,
h=0 to 12,
j=1 to 24,
with the proviso that a+b+j=c.

8. The catalyst system as claimed in claim 7,
wherein the polymer compound comprises from 0.1% by weight to 99% by weight of at least one silasesquioxane-metal complex of the formula I.

9. The catalyst system as claimed in claim 8,
wherein the polymer compound comprises from 1% by weight to 90% by weight of at least one silasesquioxane-metal complex of the formula 1.

10. The catalyst system as claimed in claim 1,
wherein the polymer compound comprises polysiloxane chains.

11. A process for preparing a catalyst system comprising a polymer compound comprising at least one silasesquioxane-metal complex, comprising preparing the polymer compound by homopolymerization, copolymerization and/or grafting of a silasesquioxane compound containing at least one unsaturated olefin radical.

12. The process as claimed in claim 11,
wherein the silasesquioxane compound is at least one compound of the formula II
R¹ₐR²_{b}Si_{c}O_{d}H_{c}X_{f}M_{g}Yₕ II
where
R¹=an aliphatic, aromatic, cyclic or acyclic hydrocarbon radical, with or without functional groups,
R²=an aliphatic, aromatic, cyclic or acyclic hydrocarbon radical containing at least one double bond,
X=one or more of H, OH, halogen, an alkoxy radical and an organosilyl radical,
M=one or more of an element of the transition groups of the Periodic Table, a lanthanide, an actinide, an element of main group 3 and an element of main group 4,
Y=an anionic radical,
a=0 to 23,
b=1 to 24,
c=5 to 24,
d=12 to 48,
e=0 to 10,
f=0 to 8,
g=0 to 4,
h=0 to 12,
with the proviso that a+b=c.

13. The process as claimed in claim 11,
wherein the silasesquioxane compound is at least one compound of the formula III
R¹ₐR²_{b}Si₇O₁₂M_{g}Yₕ III
where
R¹=an aliphatic, aromatic, cyclic or acyclic hydrocarbon radical, with or without functional groups,
R²=an aliphatic, aromatic, cyclic or acyclic hydrocarbon radical containing at least one double bond,
M=one or more of an element of the transition groups of the Periodic Table, a lanthanide, an actinide, an element of main group 3 and an element of main group 4,
Y=an anionic radical,
a=0 to 6,
b=1 to 7,
g=1,
h=1 to 3,
with the proviso that a+b=7.

14. The process as claimed in claim 11,
wherein the silasesquioxane compound is at least one compound of the formula IV
R¹ₐR²R_{b}Si₇O₁₂H₃ IV
where
R¹=an aliphatic, aromatic, cyclic or acyclic hydrocarbon radical, with or without functional groups,
R²=an aliphatic, aromatic, cyclic or acyclic hydrocarbon radical containing at least one double bond,
a=0 to 6,
b=1 to 7,
with the proviso that a+b=7.

15. The process as claimed in claim 11,
wherein the silasesquioxane compound is at least one compound of the formula V
R¹ₐR²_{b}Si₁₈O₃₇Ti₄ V
where
R¹=an aliphatic, aromatic, cyclic or acyclic hydrocarbon radical, with or without functional groups,
R²=an aliphatic, aromatic, cyclic or acyclic hydrocarbon radical containing at least one double bond,
a=0 to 17,
b=1 to 18,
with the proviso that a+b=18.

16. The process as claimed in claim 11,
wherein the silasesquioxane compound is at least one compound of the formula VI
R¹ₐR²_{b}Si₇O₁₂TiY VI
where
R¹=an aliphatic, aromatic, cyclic or acyclic hydrocarbon radical, with or without functional groups,
R²=an aliphatic, aromatic, cyclic or acyclic hydrocarbon radical containing at least one double bond,
Y=an anionic radical,
a=0 to 6,
b=1 to 7,
with the proviso that a+b=7.

17. The process as claimed in claim 11,
wherein a copolymerization and/or grafting reaction of at least one silasesquioxane compound with at least one compound containing at least one olefinically unsaturated bond and/or at least one H-heteroatom group is carried out.

18. The process as claimed in claim 17,
wherein the compound containing an olefinically unsaturated bond is a siloxane or a silasesquioxane compound.

19. The process as claimed in claim 18,
wherein the siloxane is a polydialkylsiloxane containing terminal vinyl groups.

20. The process as claimed in claim 18,
wherein the siloxane is a polydimethylsiloxane containing terminal vinyl groups.

21. The process as claimed in claim 18,
wherein the siloxane is an alkylhydrosiloxane-dialkylsiloxane copolymer.

22. The process as claimed in claim 21,
wherein the siloxane is a methylhydrosiloxane-dimethylsiloxane copolymer.

23. The process as claimed in claim 11,
wherein the preparation is carried out in bulk.

24. The process as claimed in claim 11,
wherein the preparation is carried out in the liquid phase.

25. The process as claimed in claim 11,
wherein the preparation is carried out in an aprotic solvent.

26. The process as claimed in claim 25,
wherein the aprotic solvent is toluene.

27. A process comprising oxidation or oximation of an organic compound in the presence of an oxidant and the catalyst system as claimed in claim 1.

28. The process as claimed in claim 27,
wherein the catalyst system is a heterogeneous catalyst.

29. The process as claimed in claim 27,
wherein the catalyst system is a homogeneous catalyst.

30. The process as claimed in claim 29,
wherein the catalyst system is removed from the reaction solution with at least one membrane.

31. The process as claimed in claim 27,
wherein the oxidant comprises at least hydrogen peroxide.

32. The process as claimed in claim 27,
wherein the oxidant comprises at least one organic peroxide.

33. The process as claimed in claim 32,
wherein the organic peroxide is tert-butyl hydroperoxide, ethylbenzene hydroperoxide, cumene hydroperoxide, or a mixture thereof.

34. The process as claimed in claim 27,
wherein the organic compound is at least one cyclic or acyclic, monounsaturated or polyunsaturated compound selected from the group consisting of alkanes, alkenes, alkynes, arenes, heteroarenes, alcohols, aldehydes, ketones, sulfides, sulfoxides, amines, imines, hydroxylamines, acids, amides, esters, anhydrides and acid halides.

35. A polymer compound comprising a silasesquioxane-metal complex obtained by reacting a compound having the following formula IX:
(CH₃)₃Si—O[SiHCH₃—O]ₘ—[Si(CH₃)₂—O]ₘ—Si(CH₃)₃ IX
where the ratio of methylhydrosiloxane units to dimethylsiloxane units is from 5:1 to 1:10, m is an integer or non-integer of from 3 to 20, n is an integer or non-integer of from 4 to 30, with
a compound of formula (C₆H₁₁)₆(CH₂CH)Si₇O₉(OH)₃,
a vinyl-terminated polydimethylsiloxane, and
a metal compound.

36. A polymer compound comprising a silasesquioxane-metal complex obtained by reacting a compound having the following formula IX:
(CH₃)₃Si—O[SiHCH₃—O]ₘ—[Si(CH₃)₂—O]ₘ—Si(CH₃)₃ IX
where the ratio of methylhydrosiloxane units to dimethylsiloxane units is from 5:1 to 1:10, m is an integer or non-integer of from 3 to 20, n is an integer or non-integer of from 4 to 30, with
a compound of formula (C₆H₁₁)₆(CH₂CH)Si₇O₉Ti(C₅H₅).

37. A polymer compound comprising a silasesquioxane-metal complex obtained by reacting a compound having the following formula IX:
(CH₃)₃Si—O[SiHCH₃—O]ₘ—[Si(CH₃)₂—O]ₘ—Si(CH₃)₃ IX
where the ratio of methylhydrosiloxane units to dimethylsiloxane units is from 5:1 to 1:10, m is an integer or non-integer of from 3 to 20, n is an integer or non-integer of from 4 to 30, with
a compound of formula (C₆H₁₁)₆(CH₂CH)Si₇O₉Ti(C₅H₅), and
a vinyl-terminated polydimethylsiloxane.

38. A polymer compound comprising a silasesquioxane-metal complex obtained by reacting a compound having the formula (cyclohexyl)₆(vinyl)Si₇O₁₂TiOPrⁱ or (cyclohexyl)₆(vinyl)Si₇O₁₂TiCp, with
a compound having the following formula IX:
(CH₃)₃Si—O[SiHCH₃—O]ₘ—[Si(CH₃)₂—O]ₘ—Si(CH₃)₃ IX
where the ratio of methylhydrosiloxane units to dimethylsiloxane units is from 5:1 to 1:10, m is an integer or non-integer of from 3 to 20, n is an integer or non-integer of from 4 to 30, and
a vinyl-terminated polydimethylsiloxane.
